(19) United States
(12) Patent Application Publication
(10) Pub. No.: US 2008/0195859 A1
(43) Pub. Date: Aug. 14, 2008

(54) Safe, Alert, Biz, Gold and Com2 software

(76) Inventor: Joseph Frank Johns, New Lenox, IL (US)

Correspondence Address: IPADVISORS, 2038 N. CLARK STREET, STE. 105, CHICAGO, IL, 60614, US

(21) Appl. No.: 11/673,985

(22) Filed: Feb. 12, 2007

(51) Int. Cl. G06F 15/16; H04L 9/32

(52) U.S. Cl. 713/153; 709/206

(57) ABSTRACT

A system in which users can access a website to sign up and select from a variety of alert options, targeted messages can then be sent to them from our software via text messages on their cellular phone. The user's information is input into a database that is used by our software to direct the text messages. Our software groups users based on the options they select to ensure they get only messages they opt to get. The software then sends out text messages to the users in a group's cellular phone when there is pertinent information for those individuals.

### BACKGROUND AND SUMMARY OF THE INVENTION

Shown here is the data flow from Xstream Biz Pro's client application to Xstream's Messaging Server. The diagram displays how the information is locally stored, passed through web scripting, stored remotely and passed to external SMTP (Email) networks. The server and client communication is made possible through the use of web posting and XML variant. Microsoft access is used for local data storage and MySql for server data storage.

### BRIEF DESCRIPTION OF THE DRAWINGS

The detailed description particularly refers to the accompanying figures in which:

FIG. 1 is a schematic showing one embodiment of the present invention.

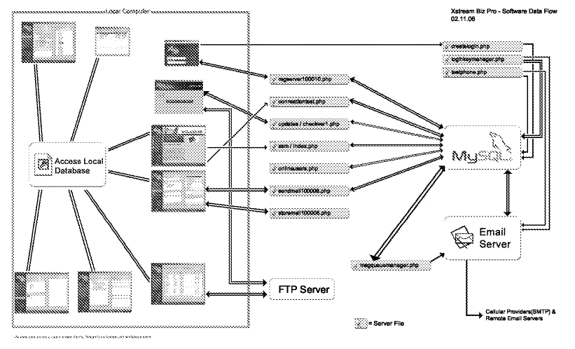

### DETAILED DESCRIPTION OF THE DRAWINGS

This system was designed to accelerate the delivery of cellular text messages for sending messages by municipalities' safety agencies and police or small to large business. On the safety side it's designed to delineate contacts by groups, sectors, regions and allow delivery based on specific requests of the end-user or cellular subscriber.

The corporate and safety based software is designed to allow residents, businesses and customers to interact through an opt in opt out environment helping to insure that the customer only receives messages they want. This is achieved through the use of the database, which calculates the needs based on the customers or end-users input. Operating, if need be in a non-web reliant environment utilizing a broadband cellular connection.

There are various versions of the software each designed to fulfill a need in different professional and safety sectors based on a number of users and maximum messaging parameters.

The system is designed to allow both purposes of safety and corporate customers or end-users to test their cell phone at the point of entry and to pick the messages they wish to receive. This is editable at any time there after should the end user wish to change there configuration.

What is claimed is:

1. A method for sending mass notification messages to cellular and email devices through the combination of a client side application, HTTP requests to a web server, web scripting and SMTP mail server.

2. The combination defined in claim 1, wherein the client side application is comprised of functions to add, edit, group and regionalize contacts to be attached to a message.

3. The combination defined in claim 1, wherein the client side application is comprised of functions to send messages as email or text message.

4. The combination defined in claim 3, wherein sending messages as text message through provider's SMTP and SNPP gateway.

5. The combination defined in claim 1, wherein the client side application is comprised of functions to save, import, schedule and track message delivery.

6. The combination defined in claim 1, wherein the client side application is comprised of functions to add, edit, group and regionalize contacts to be attached to a message.

7. The combination defined in claim 1, wherein the HTTP requests to a web server are standard web form posts used for authenticating logins to application.

8. The combination defined in claim 7, wherein users are authenticated using custom encryption coding.

9. The combination defined in claim 8, encryption coding uses an algorithm using addition and subtraction of ASCII values delimited by the character X.

10. The combination defined in claim 1, wherein the HTTP requests to a web server are standard web form posts to query server side contacts downloaded via XML data.

11. The combination defined in claim 10, contacts downloaded via XML are parsed and displayed in client side application.

12. The combination defined in claim 1, wherein the HTTP requests to a web server are standard web form posts of message information to the message queue database.

13. The combination defined in claim 12, wherein message queue database is acquired frequently, throttled and quantity limited.

14. The combination defined in claim 12, wherein message queue database creates final message destination to the SMTP mail server.

15. The combination defined in claim 5, wherein message delivery scheduled using custom calendar object by date and time.

16. The combination defined in claim 6, wherein message groups may be combined using an ‘and’ operator for advanced message routing.

17. The combination defined in claim 16, wherein an ‘and’ operator for advanced message routing can combine cities, zip codes or regions.

18. The combination defined in claim 1, wherein the web scripting allows contacts to directly import contact information into server database from any web based browser.

19. The combination defined in claim 18, wherein information is separated by selected delivery groups.
